(19) United States
(12) Patent Application Publication
(10) Pub. No.: US 2026/0168827 A1
(43) Pub. Date: Jun. 18, 2026

(54) CAPACITIVE SENSOR ASSEMBLY FOR A FIELD DEVICE, AND FIELD DEVICE

(71) Applicant: Endress+Hauser Flowtec AG, Reinach (CH)

(72) Inventors: Rainer Höcker, Waldshut (DE); Anton Rieger, Weil am Rhein (DE)

(21) Appl. No.: 19/131,274

(22) PCT Filed: Nov. 3, 2023
(86) PCT No.: PCT/EP2023/080670

§ 371 Date: May 20, 2025

(30) Foreign Application Priority Data
Nov. 30, 2022 (DE) 10 2022 131 694.7

(51) Int. Cl. G01F 1/32

(52) U.S. Cl. CPC G01F 1/3209

(57) ABSTRACT

A capacitive sensor assembly for a field device pertaining to automation technology includes a circuit carrier having a gap section projecting into a gap between two housing elements, with a circuit arrangement, the circuit arrangement having at least one electrically conductive conductor element with an electrically insulating layer covering the conductor element. A first electrode of a capacitor unit is formed by at least one electrically conductive conductor element of the circuit arrangement and one or more second electrode(s) of the capacitor unit is/are formed by the electrically conductive wall(s) facing the gap section, namely the inner wall of the second housing element and/or the outer wall of the first housing element. Also disclosed is a field device pertaining to automation technology.

The invention relates to a capacitive sensor assembly for a field device used in automation technology and to a field device used in automation technology.

In principle, all measuring devices for determining and/or monitoring process variables which are used close to the process and supply or process process-relevant information are referred to as field devices in the context of this application. These are, for example, fill-level measuring devices, flow meters, pressure and temperature measuring devices, pH-redox potential meters, conductivity meters, etc., which are used for recording the respective process variables, such as fill level, flow, pressure, temperature, pH level, and conductivity of a process medium. Such field devices are manufactured and distributed by Endress+Hauser in a wide range of designs.

Capacitive sensor assemblies are used, for example, in capacitive fill-level measuring devices, pressure measuring devices, and vortex flow meters.

The latter are used, for example, to measure flow velocities of fluids flowing in pipelines, in particular fast-flowing and/or hot gases (>100° C.) and/or fluid flows with a high Reynolds number (Re>10,000), or volume or mass flow rates corresponding to a particular flow velocity. Examples of such vortex flow meters are known, inter alia, from U.S. Pat. Nos. 4,716,770, 6,003,384, 6,910,387, 6,938,496, 9,719,819, 1,0845,222, or 1,0948,321 and are also offered, inter alia, by the applicant—for example, under the trade names “PROWIRL D 200,” “PROWIRL F 200,” “PROWIRL O 200,” “PROWIRL R 200.”

Such vortex flow meters have a bluff body against which the fluid flows and which serves to create a so-called Kármán vortex street composed of vortices arranged in sequence within a fluid sub-volume flowing directly downstream of the bluff body. It is known that the vortices are generated at the bluff body at a shedding rate (1/fᵥₜₓ) that depends upon the flow velocity. The vortex flow meters further have a (vortex) sensor which is integrated into the bluff body, or connected thereto, or arranged downstream thereof in the flow, specifically in the region of the Kármán vortex street. The sensor is used to detect pressure fluctuations within the Kármán vortex street formed in the flowing fluid and to convert these into a measurement signal representing the pressure fluctuations, in particular a capacitive measurement signal. The measurement signal corresponds to a pressure, prevailing within the fluid, which is subject to periodic fluctuations due to counter-rotating vortices downstream of the bluff body, and has a signal frequency corresponding to the shedding rate of the vortices (˜fᵥₜₓ).

For this purpose, the sensor has a thin deformation body made of metal (measuring membrane) and a (mechanical) sensor assembly formed from a predominantly rod-shaped, planar, wedge-shaped, or paddle-shaped sensor vane (referred to as a “paddle”), which extends from a substantially planar surface of the deformation body. The mechanical sensor assembly is designed to detect pressure fluctuations in the Kármán vortex street and to convert them into movements of the deformation body that correspond to the pressure fluctuations.

For the purpose of generating the measurement signal, the sensor comprises a transducer element, arranged directly on the aforementioned surface of the deformation body, facing away from the surface carrying the sensor vane and/or in the vicinity thereof. The transducer element is formed by means of a capacitor unit, with variable measuring capacitance, which is mechanically coupled to the deformation body and is configured to detect movements of the deformation body or of the compensation body, if present, viz., via a corresponding change in the measuring capacitance of the capacitor unit, such that the measurement signal can be generated by a capacitive sensor assembly.

Capacitor units used in the prior art and based upon electrodes that are to be sealed in glass have the disadvantage of low robustness and are also complex to manufacture. This is also the case, for example, because the dielectric between the electrodes is often evacuated and/or filled with protective gas.

The object addressed by the invention is therefore that of providing a capacitive sensor assembly for a field device used in automation technology that is as easy to manufacture and as robust as possible.

The object is achieved by a capacitive sensor assembly for a field device used in automation technology and by a field device used in automation technology.

Regarding the sensor assembly, the object is achieved by a capacitive sensor assembly for a field device used in automation technology, which sensor assembly comprises:
a first housing element and a second housing element; and
a circuit carrier;
wherein the second housing element spatially surrounds the first housing element at least partially such that a gap is present between an inner wall of the second housing element and an outer wall of the first housing element,
wherein the inner wall of the second housing element and/or the outer wall of the first housing element is electrically conductive, in particular metallic; and
wherein the circuit carrier has at least one gap section, projecting into the gap, with a circuit arrangement,
wherein the circuit arrangement has at least one electrically conductive conductor element with an electrically insulating layer covering the conductor element,
wherein the gap section projects into the gap such that a first surface of the gap section faces the outer wall of the first housing element, and a second surface of the gap section faces the inner wall of the second housing element,
wherein in particular the second surface of the gap section is opposite the first surface of the gap section;
wherein the gap section has the electrically insulating layer at least on whichever of the first surface and the second surface faces an electrically conductive wall, viz., the inner wall of the second housing element and/or the outer wall of the first housing element,
so that at least one first electrode of a capacitor unit is formed by the at least one electrically conductive conductor element of the circuit arrangement of the gap section,
that one or more second electrodes of the capacitor unit are formed by the electrically conductive wall(s) facing the gap section, viz., the inner wall of the second housing element and/or the outer wall of the first housing element,
and
that the dielectric of the capacitor unit is formed by the volume, occupied in the gap, between the gap section and the electrically conductive wall(s) facing the gap section, viz., the inner wall of the second housing element and/or the outer wall of the first housing element, and by an electrically insulating portion of the gap section.

In particular, the gap section is adapted to the shape of the first housing element and the second housing element. The circuit carrier is therefore, in particular, formable, in particular flexible, at least in sections, or shape-adaptable (also: freely shapeable in its form).

The advantages of the invention are as follows:
The capacitor unit is formed very simply, viz., by at least one electrically conductive wall and a circuit carrier arranged in the gap between the two housing elements.
The layers of the circuit carrier that insulate the conductor elements directly provide the insulation between the conductive walls of the housing elements and the conductor elements. The two housing elements are therefore at least not directly electrically connected to each other via the conductor elements. However, they can be electrically connected to each other in other ways—for example, by being part of a common structural unit.
The glass sealing of electrodes in a capacitor unit, as used in the prior art, is no longer required. On the one hand, this results in a significant reduction in manufacturing costs. On the other hand, even in the event of overloading of the deformation body and/or severe asymmetric deformation, a short circuit is not possible. This also applies if conductive liquids and/or conductive particles such as metal chips enter the gap.
Neither evacuation of the gap nor the introduction of a protective gas into the gap is necessary to ensure adequate insulation, even under overload conditions.
The circuit carrier can be inserted into the gap from outside, in particular pushed in. It can therefore be inserted very easily and, in particular, can also be replaced directly within the process.
The use of the circuit carrier introduced into the gap enables direct integration and/or very simple connection of a connecting cable that serves to transmit the capacitive measurement signal generated by the capacitor unit. This connecting cable can be integrated directly into the circuit carrier or connected to the conductor elements of the gap section to detect and transmit the capacitance(s) of the capacitor unit serving as the measurement signal.

In one embodiment of the sensor assembly, both the inner wall of the second housing element and the outer wall of the first housing element are electrically conductive, in particular metallic, wherein in particular both the first housing element and the second housing element are electrically conductive, in particular metallic.

In this case, the capacitive sensor assembly therefore has a capacitor unit with two capacitors—viz., with electrodes formed by the two conductive walls, i.e., the outer walls and the inner wall, as well as the conductor elements. As a result, the sensitivity of the capacitor unit is doubled, e.g., in the case of the vortex flow meters mentioned above, compared to their conventional design.

In one embodiment of the sensor assembly, the first housing element and the second housing element are at least partially cylindrical and in particular concentric.

In this case, the gap is in particular annular. In particular, it is a round gap.

In one embodiment of the sensor assembly, the gap section is curved, in particular with a curvature that is adapted to the contour of the cylindrical section of the first housing element and the second housing element. In the case of at least partially cylindrical housing elements in which the gap section lies opposite the cylindrical sections of the housing elements, the circuit carrier, which is at least partially formable or adapted in shape, is curved in such a way, in the state in which it is inserted into the gap, that the gap section is uneven and, in particular, follows the curvature of the cylindrical section.

In a preferred embodiment of the sensor assembly, the circuit carrier is a circuit board which is at least partially flexible,
wherein at least the gap section is designed as at least one flexible circuit board section.

Fully flexible or only partially flexible circuit boards and their use as circuit carriers are known from the prior art, wherein the latter are also referred to as semi-flexible or semi-flex circuit boards. Designing the gap section as a flexible circuit board section allows it to be easily adapted to the shape of the two housing elements. For example, in the aforementioned case of the partially annular gap or round gap, the gap section is curved in such a way that it essentially follows the curvature of the partially annular gap.

In one embodiment of the sensor assembly, the gap section comprises a first flexible circuit board section and a second flexible circuit board section,
wherein the first flexible circuit board section and the second flexible circuit board section are arranged at different regions of the gap.

Preferably, the two flexible circuit board sections are arranged at different, in particular opposite, regions of the, in particular, annular gap.

For this purpose, for example, the first flexible circuit board section is connected to the second flexible circuit board section by means of a flexible connection segment that protrudes from the gap.

In one embodiment of the sensor assembly, the circuit carrier is a circuit carrier produced using a method for producing three-dimensional injection-molded circuit carriers.

Such a circuit carrier is an injection-molded plastic part (molded interconnect device, MID) into which a metallic structure is introduced, which in this case serves as the at least one conductor element or as the at least one first electrode of the capacitor unit. There are virtually no constraints upon the geometric shape of the plastic part or upon the spatial arrangement of the metallic structure within the plastic part. An overview of the common manufacturing processes for MID's is published, for example, by the “Forschungsvereinigung Räumliche Elektronische Baugruppen 3-D MID e.V.” (Research Association for Mechatronic Integrated Devices 3-D MID). Similar to the aforementioned variant of the flexible circuit board, the advantage of a circuit carrier formed as an MID is the almost completely free geometric design of the circuit carrier, so that the shape of the circuit carrier can be optimally adapted to the shape of the housing elements and/or to that of the gap.

In one embodiment of the sensor assembly, the gap section is mechanically connected to the first housing element and the second housing element, in particular in a force-fitting manner, preferably exclusively in a force-fitting manner, in that the gap section is clamped between the first housing element and the second housing element in the gap.

It is particularly advantageous that no additional connecting elements and/or additional process steps (gluing, potting, etc.) are required to connect the housing elements to the circuit carrier. The gap is therefore free of any additional potting, adhesive, or any other connecting means commonly used in assembly and interconnection technology (AVT) for mechanically connecting the circuit carrier and the housing element, e.g., mechanical plug connections such as rivets for additional form-fitting connection. As a result, the circuit carrier is particularly easy to replace, by pulling out the circuit carrier to be replaced and clamping in a new circuit carrier.

Furthermore, the sensor assembly also has a high vibration resistance due to the clamping. This also applies to a connecting section mentioned below, which adjoins the gap section and protrudes from the gap.

In one embodiment of the sensor assembly, the gap section is free of electronic components, and the circuit arrangement has, in particular essentially exclusively, conductor tracks as the conductor element(s).

In one embodiment of the sensor assembly, the gap has a gap width of less than 2 mm, wherein the gap width is in particular between 0.1 and 0.5 mm. The gap width is defined in particular as a maximum distance between the outer wall of the first housing element and the inner wall of the second housing element.

In one embodiment of the sensor assembly, the electrically insulating layer of the gap section comprises polyimide and is in particular formed as an electrically insulating film made of a polyimide.

Polyimide is characterized by extremely high temperature resistance, especially at temperatures up to over ca. 300° C., and high mechanical stability.

Such polyimide films are marketed, for example, under the following trade names or by the following manufacturers:
APICAL®—Kaneka Americas Holding, Inc.
KAPTON® or VESPEL®—DuPont
KINEL®—Vyncolit N.V.
MELDIN®—Saint Gobain
P 84®—Evonik Industries
UPILEX®—Ube Industries, Ltd.

In one embodiment of the sensor assembly, the circuit carrier is a semi-flexible or fully flexible circuit board, wherein the circuit carrier has a connecting section that adjoins the gap section and protrudes from the gap.

In one embodiment of the sensor assembly, the at least one electrically insulating layer of the circuit arrangement of the gap section and the at least one conductor element of the circuit arrangement of the gap section are extended into the connecting section.

In one embodiment of the sensor assembly, the semi-flexible or fully flexible circuit board has, in the connecting section, a shielding element that serves to shield against electromagnetic interference fields.

In one embodiment of the sensor assembly, the shielding element comprises:
an electrically conductive surface layer, which conductive surface layer covers the electrically insulating layer, in particular over the full area;
an electrically insulating layer, which insulating layer covers the conductive surface layer, in particular over the full area,
   wherein the conductive surface layer(s) and the insulating layer(s) are formed as layers of the semi-flexible or fully flexible circuit board.

Preferably, the insulating layers are formed similarly to the electrically insulating layers introduced above, and in particular also comprise polyimide.

In one embodiment of the sensor assembly, the circuit carrier is a flexible circuit board, in particular a fully flexible circuit board, wherein a connecting element, in particular a plug-in connector element, is arranged on the connecting section,
and wherein in particular the connecting element can be electrically contacted with a rigid circuit board via an electrical feedthrough.

In one embodiment of the sensor assembly, the circuit carrier is a semi-flexible circuit board, wherein the semi-flexible circuit board comprises a rigid section, and wherein the rigid section comprises the connecting section and/or wherein the rigid section adjoins the connecting section.

Advantageously, further components can be arranged on the rigid section or the rigid circuit board, e.g., a vibration sensor, in particular an acceleration sensor, or a temperature sensor.

In one embodiment of the sensor assembly, the gap is formed as an air gap. This is a particularly simple variant in terms of manufacturing technology, in which the gap does not need to be evacuated or filled with protective gases.

With regard to the field device, the object is achieved by a field device used in automation technology for detecting a process variable of a medium, wherein the field device has a capacitive sensor assembly according to the invention.

In one embodiment of the field device, the capacitor unit serves as a signal generation unit of the field device for generating at least one capacitive measurement signal dependent upon a process variable, and the field device has a measurement electronics unit connected to the signal generation unit, which measuring electronics unit serves to process and/or forward a capacitive measurement signal generated by the signal generation unit.

In one embodiment of the field device, the field device comprises a rigid circuit board, which is electrically contacted with the connecting element by means of an electrical feedthrough, and wherein the rigid circuit board is part of the measuring electronics unit.

In an alternative embodiment to the last embodiment mentioned, the rigid section of the semi-flexible circuit board forms part of the measuring electronics unit.

In one embodiment of the field device, the field device comprises a media-contacting section, wherein the measuring electronics unit is arranged at a distance of at least 50 mm from the media-contacting section.

In one embodiment of the field device, the medium is a flowing fluid, wherein the sensor assembly serves as a sensor element for capacitively detecting pressure fluctuations of a Kármán vortex street formed in the flowing fluid.

The invention further comprises the use of a field device according to the invention for detecting a flow parameter, in particular a flow velocity and/or a volume and/or mass flow rate, of a fluid flowing in a pipeline with a fluid temperature of more than 400° C. and/or with a pressure of more than 250 bar, in particular steam.

The invention will be explained further with reference to the figures, which are not true-to-scale, wherein the same reference signs designate the same features. For reasons of clarity, or if it appears sensible for other reasons, previously noted reference signs will not be repeated in the subsequent figures.

Shown are:

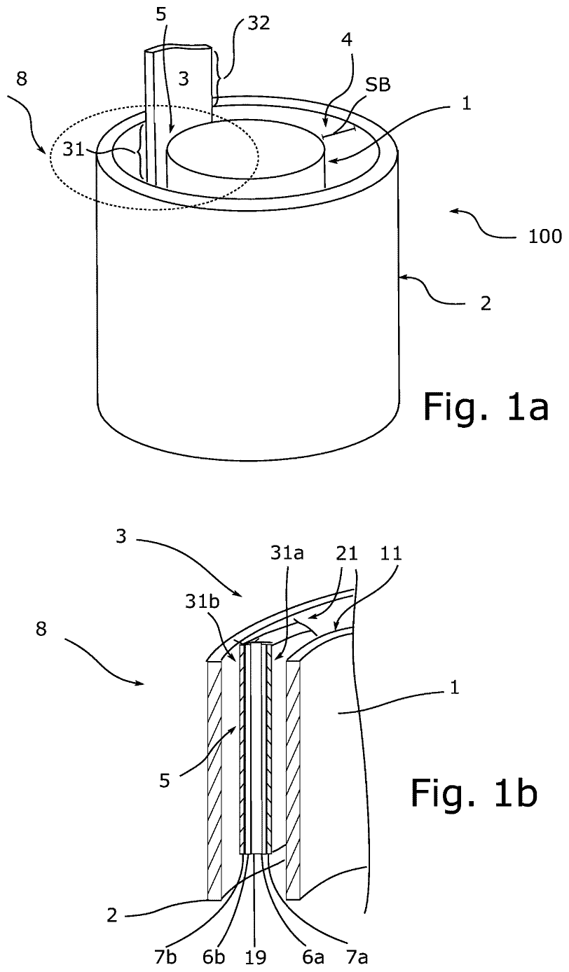

FIG. 1a, 1b: Various views of an embodiment of a capacitive sensor assembly 100 according to the invention;

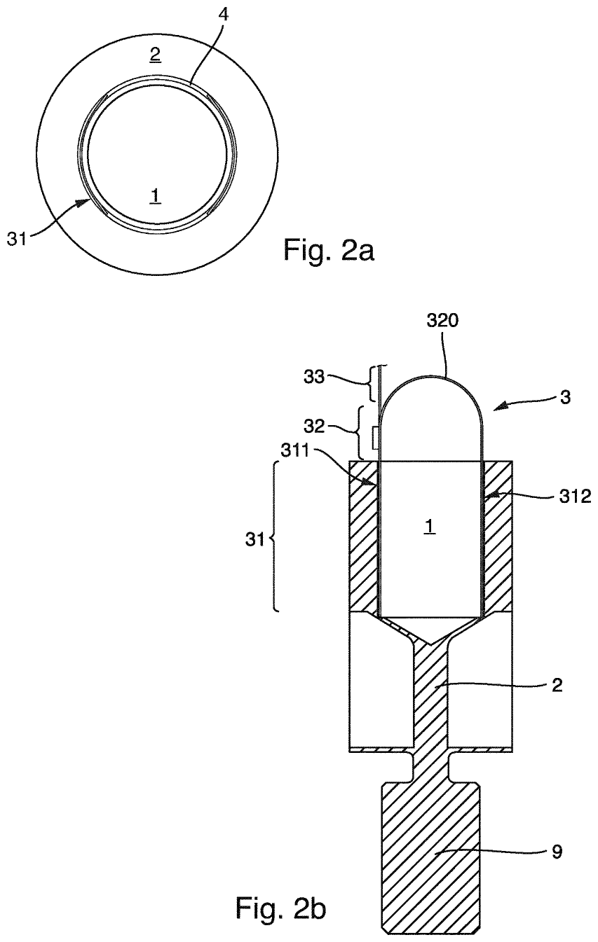

FIG. 2a, 2b: Various views of an embodiment of a capacitive sensor assembly 100 according to the invention in conjunction with a field device component;

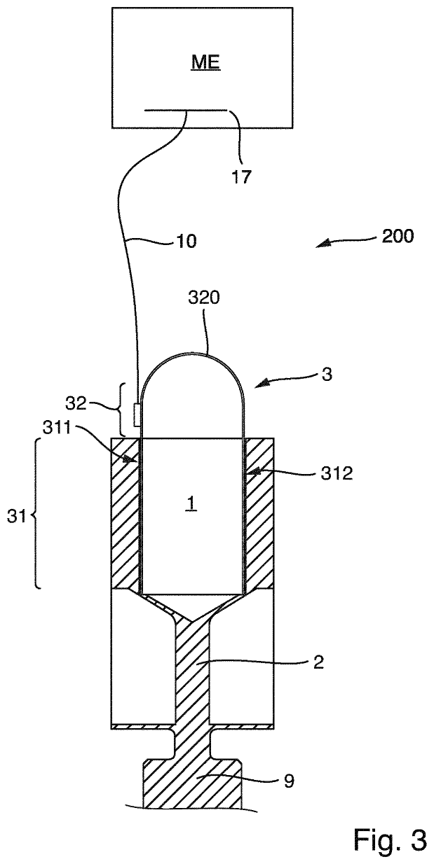

FIG. 3: A view of an embodiment of a field device 200 with a sensor assembly 100 according to the invention, and;

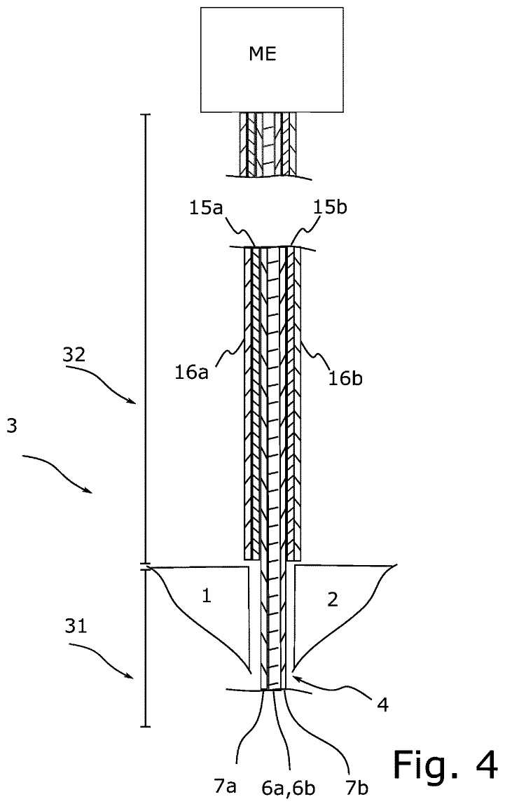

FIG. 4: A view of an embodiment of a field device 200 with a sensor assembly 100 according to the invention with a shielding element.

FIG. 1a shows a perspectival view of a section of a sensor assembly 100 according to the invention. A metallic, cylindrical first housing element 1 is surrounded by a second metallic housing element 2 such that a gap 4 with a gap width SB is present between the two housing elements 1, 2. The gap width SB is between 0.1 and 0.5 mm.

In this exemplary embodiment, for the sake of clarity, both housing elements 1, 2 are metallic and thus electrically conductive, but this is of course not essential to the invention; it is sufficient that at least the inner wall 21 of the second housing element 2 or the outer wall 11 of the first housing element 1 be electrically conductive. The circuit carrier 3 is arranged with respect to the housing elements 1, 2 in such a way that it projects into the gap 4 with a gap section 31. The circuit carrier 3 also has a connecting section 32 located outside the gap 4 and adjoining the gap section 31 (cf. also FIG. 2 to 3). In the gap section 31, the circuit carrier 3 has a circuit arrangement 5 with at least one conductor element 6a; 6b. As a result, the gap section 31 in combination with the housing elements 1, 2 forms a capacitor unit 8.

This is illustrated in FIG. 1b, which shows in more detail the portion shown in the dashed, circled area of FIG. 1a. Connecting section 32 is not shown here for the sake of clarity. The circuit arrangement 5 of the circuit carrier 3 comprises a central carrier element 19, on both sides of which conductor elements 6a, 6b are arranged, each of which is covered by an electrically insulating layer 7a, 7b. The carrier element 19 is also not essential to the invention; as long as the circuit carrier 3 is sufficiently stable, it is also entirely possible to provide only one or more central conductor elements 6a; 6b, which are covered on both sides by electrically insulating layers 7a, 7b and thus encapsulated between them.

The outer wall 11 of the first housing element 1 lies opposite the first surface 31a of the gap section 31 and is insulated from the first conductor element 6a due to the electrically insulating layer 7a and the free volume in the gap 4. The conductor element 6a thus forms a first electrode of the capacitor unit 8, and the outer wall 11 forms a second electrode of the capacitor unit 8. The inner wall 21 of the second housing element 2 lies opposite the second surface 31b of the gap section 31 and is insulated from the second conductor element 6b due to the electrically insulating layer 7b and the free volume in the gap 4. The second conductor element 6b thus forms a further first electrode of the capacitor unit 8, and the inner wall 21 of the second housing element 21 forms a further second electrode of the capacitor unit 8.

The housing elements 1, 2 are mounted so as to be moveable relative to one another. During a relative movement of the housing elements 1, 2 and the circuit carrier 3 with respect to one other, the distance between the electrodes of the capacitor unit 8 changes, thus changing the capacitance of the capacitor unit 8, which serves as the measurement signal MS. Due to the use of two electrically conductive walls 11, 21, two capacitive measurement signals MS can be detected with the capacitor unit 8.

FIG. 2a shows a top view of another embodiment of the capacitive sensor assembly 100. In this embodiment, the second housing element 2 essentially completely surrounds the inner first housing element 1. The gap section 31 of the circuit carrier 3 is designed as a curved, flexible circuit board, wherein the curve of the flexible circuit board 31 is adapted to the shape of the round gap 4. The flexible circuit board is characterized by high stability combined with flexibility of form. Although the exemplary embodiments described here and below are explained in connection with flexible circuit boards, the solution according to the invention comprises all other formable or shape-adaptable (also: freely shapeable in their form) circuit carriers 3, such as the injection-molded circuit carriers or MID's mentioned above.

The flexible circuit board 31 is clamped into the gap 4 from above in such a way that a force-fitting connection is established between the circuit carrier 3 and the housing elements 1, 2. This makes it very easy to insert the circuit carrier 3 into the gap 4 and, in the event of a fault, to replace it readily within the process.

In the embodiment shown in FIG. 2, the gap section 31 comprises a first gap section 311 and a second gap section 312 opposite thereto. The two gap sections 311, 312 are positioned in different regions of the gap 4. As a result, the number of electrodes and the detectable measuring capacitances serving as the measuring signal MS are increased, thus further enhancing the sensitivity of the capacitor unit 8 of the capacitive sensor assembly 100.

The first gap section 311 is connected to the second gap section 312 by means of a curved connection segment 320 made of flexible circuit board material. This is shown in FIG. 2b in a 90° rotated view of the arrangement already shown in FIG. 2a—here, in a lateral sectional view. The connection segment 320 connects the two gap sections 311, 312 outside the gap 4 to one another by connecting to a flexible connecting section 32 which adjoins the first gap section 311 and which protrudes from the gap 4. A connecting element 17 is arranged on the connecting section 32, e.g., a plug-in connector element, which serves to connect a connecting cable 10 (cf. FIG. 3). Where applicable, the circuit carrier 3 may also comprise a rigid section 33 adjoining the flexible connecting section 32; the circuit carrier 3 may of course also be designed as a fully flexible circuit board.

The second housing element 2 transitions into a sensor vane 9 at an end facing away from the first housing element 1, such that the sensor assembly 100 serves as a sensor element for capacitively detecting pressure fluctuations of a Kármán vortex street formed in the flowing fluid, and can be used in a vortex flow meter 200 mentioned above.

This is illustrated in FIG. 3, which schematically illustrates such a field device 200. The capacitive sensor assembly 100 essentially corresponds to the embodiment already shown in FIG. 2b, except that here the connecting section 32 is designed to be completely flexible. The capacitor unit 8 of the sensor assembly 100 thus serves here as a signal generation unit of the field device 200 for generating at least one capacitive measuring signal MS dependent upon a process variable. Furthermore, the field device 200 has a measuring electronics unit ME connected to the signal generation unit by means of a connecting cable 10. The measuring electronics unit ME is used to process and/or forward the capacitive measuring signal MS generated by the signal generation unit. For this purpose, it naturally includes further electronic components and/or circuit arrangements, such as those used in measuring electronics units ME (also: transmitter unit) known from the prior art, which will not be discussed in detail here for the sake of clarity. The same applies to further details regarding the design of the vortex flow meter; in this regard, the applicant refers to the prior art mentioned above.

The paddle-shaped sensor vane 9 comes into contact with the fluid during operation of the field device 200. For high-temperature applications, it is therefore advantageous if the circuit carrier 3 is sufficiently heat-resistant at its end facing the medium, particularly at the gap section 31. This is achieved here by the flexible circuit board 31 having polyimide as an electrically insulating layer 7a; 7b (and possibly also as a carrier element 19, if present), which is characterized by excellent temperature resistance in an operating range from −196° C. to over 300° C. This makes the sensor assembly 100 suitable for direct process use in the aforementioned hot gas applications of the vortex flow meters. Since only the end, facing away from the circuit carrier 3, of the sensor assembly 100, viz., the sensor vane 9, is in contact with the media and arranged at a slight distance from the circuit carrier 3, use at fluid temperatures of over 400° C., e.g., up to 450° C., is entirely possible without causing a short circuit between the electrodes of the capacitor unit 8, which would be caused, for example, by a complete melting of the electrically insulating layers 7a; 7b.

The gap 4 is further formed here as an air gap, in which ambient air can flow in and out without obstruction, so that a complicated evacuation of the gap 4, as is otherwise usual with vortex flow meters, is no longer necessary in the context of the invention.

The components of the measuring electronics unit ME may have a lower temperature resistance than the gap section 31 of the circuit carrier 3. Therefore, the measuring electronics unit ME is further sufficiently distanced from the gap section 31.

The use of a connecting cable 10 is not necessary; depending upon the design, the conductor elements 6a; 6b can be extended up to the measuring electronics unit ME, in order to detect the measuring signals MS.

This is illustrated in more detail in FIG. 4, which shows a circuit carrier 3 inserted into the gap 4 between the housing elements 1, 2. The circuit carrier 3 here comprises the aforementioned gap section 31 and transitions into the connecting section 32 outside the gap 4. The connecting section 32 can be rigid-flexible or fully flexible. Both the conductor elements 6a; 6b and the layers 7a; 7b electrically insulating the conductor elements 6a; 6b are extended into the connecting section 32 outside the gap 4. The extended conductor elements 6a; 6b here assume the function of forwarding the measuring signal MS to the measuring electronics unit ME of the connecting cable 10 shown in FIG. 3.

Outside the gap 4, electromagnetic interference fields may have a disruptive influence on the conductor elements 6a, 6b, which distorts the measuring signal MS detected and/or transmitted by the capacitor unit 8. In order to reduce the influence of electromagnetic interference fields, the circuit carrier 3 comprises a shielding element in the connecting section 32. For this purpose, the circuit carrier 3 comprises internal conductive surface layers 15a, 15b in the connecting section 32, which cover the electrically insulating layers 7a, 7b to shield against possible interference fields. This full-area coverage applies in particular over the entire surface of the respective electrically insulating layers 7a, 7b. The conductive surface layers 15a, 15b are in turn each covered by a further, in particular full-area, insulating layer 16a, 16b. This applies to each conductor element 6a; 6b extended into the connecting section 32 and to each electrically insulating layer 7a, 7b extended into the connecting section 32. The insulating layers 16a, 16b are in particular made of polyimide. The shielding element is thus advantageously formed directly by layers 15a, 15b, 16a, 16b of the circuit carrier 3, which is designed as a semi-flexible or fully flexible circuit board.

### REFERENCE SIGNS AND SYMBOLS

100 Capacitive sensor assembly
1 First housing element
11 Outer wall
2 Second housing element
21 Inner wall
3 Circuit carrier
31 Gap section
31a, 31b First and second surface
311, 312 First, second gap section
32 Connecting section
320 Connection segment
33 Rigid section
4 Gap
5 Circuit arrangement
6a, 6b, Conductor elements
7a, 7b, Electrically insulating layers
8 Capacitor unit
9 Sensor vane
10 Connecting cable
15a,15b Conductive surface layers
16a,16b Insulating layers
17 Connecting element
18 Rigid circuit board
19 Support element
200 Field device
SB Gap width
MS Measurement signal
ME Measuring electronics unit

1-25. (canceled)

26. A capacitive sensor assembly for a field device used in automation technology, comprising:
a first housing element and a second housing element; and
a circuit carrier;
wherein the second housing element spatially surrounds the first housing element at least in sections such that a gap is present between an inner wall of the second housing element and an outer wall of the first housing element,
wherein the inner wall of the second housing element and/or the outer wall of the first housing element is electrically conductive,
wherein the circuit carrier has at least one gap section projecting into the gap with a circuit arrangement,
wherein the circuit arrangement has at least one electrically conductive conductor element with an electrically insulating layer covering the conductor element,
wherein the gap section projects into the gap such that a first surface of the gap section faces the outer wall of the first housing element and a second surface of the gap section faces the inner wall of the second housing element,
wherein the second surface of the gap section is opposite the first surface of the gap section,
wherein the gap section that faces an electrically conductive wall viz., the inner wall of the second housing element and/or the outer wall of the first housing element, has the electrically insulating layer such that:
a first electrode of a capacitor unit is formed by the at least one electrically conductive conductor element of the circuit arrangement of the gap section,
one or more second electrodes of the capacitor unit are formed by the electrically conductive walls facing the gap section, viz., the inner wall of the second housing element and/or the outer wall of the first housing element, and
a dielectric of the capacitor unit is formed by the volume occupied in the gap between the gap section and the electrically conductive wall facing the gap section, viz., the inner wall of the second housing element and/or the outer wall of the first housing element, and by an electrically insulating portion of the gap section.

27. The capacitive sensor assembly according to claim 26, wherein both the inner wall of the second housing element and the outer wall of the first housing element are electrically conductive, and
wherein both the first housing element and the second housing element are electrically conductive.

28. The capacitive sensor assembly according to claim 26,
wherein the first housing element and the second housing element are at least partially cylindrical and concentric.

29. The capacitive sensor assembly according to claim 28, wherein the gap section is curved with a curvature that is adapted to the contour of the cylindrical portion of the first housing element and the second housing element.

30. The capacitive sensor assembly according to claim 26,
wherein the circuit carrier is a circuit board which is at least partially flexible, and
wherein the gap section is formed as at least one flexible circuit board section.

31. The capacitive sensor assembly according to claim 30,
wherein the gap section comprises a first flexible circuit board section and a second flexible circuit board section, and
wherein the first flexible circuit board section and the second flexible circuit board section are arranged at different regions of the gap.

32. The capacitive sensor assembly according to claim 26,
wherein the circuit carrier is a circuit carrier produced by a method for producing three-dimensional injection-molded circuit carriers.

33. The capacitive sensor assembly according to claim 26,
wherein the gap section is mechanically connected to the first housing element and the second housing element in that the gap section is clamped between the first housing element and the second housing element in the gap.

34. The capacitive sensor assembly according to claim 26,
wherein the gap section is free of electronic components, and the circuit arrangement has conductor tracks as the conductor element(s).

35. The capacitive sensor assembly according to claim 26,
wherein the gap has a gap width of less than 2 mm.

36. The capacitive sensor assembly according to claim 26,
wherein the electrically insulating layer of the gap section comprises polyimide.

37. The capacitive sensor assembly according to claim 26,
wherein the circuit carrier is a semi-flexible or fully flexible circuit board, and
wherein the circuit carrier has a connecting section adjoining the gap section and the connecting section protrudes from the gap.

38. The capacitive sensor assembly according to claim 37,
wherein the insulating layer of the circuit arrangement and the at least one conductor element of the circuit arrangement are extended into the connecting section.

39. Capacitive sensor assembly according to claim 37,
wherein the semi-flexible or fully flexible circuit board has a shielding element in the connecting section, which shielding element serves to shield against electromagnetic interference fields.

40. The capacitive sensor assembly according to claim 39,
wherein the shielding element includes:
an electrically conductive surface layer that covers the electrically insulating layer; and
an electrically insulating layer that covers the conductive surface layer, and
wherein the electrically conductive surface layer and the electrically insulating layer are formed as layers of the semi-flexible or fully flexible circuit board.

41. The capacitive sensor assembly according to claim 37,
wherein a connecting element is arranged on the connecting section, and
wherein the connecting element can be electrically contacted with a rigid circuit board via an electrical feedthrough.

42. The capacitive sensor assembly according to claim 41,
wherein the circuit carrier is a semi-flexible circuit board having a rigid section and the rigid section includes the connecting section and/or adjoins the connecting section.

43. The capacitive sensor assembly according to claim 26,
wherein the gap is formed as an air gap.

44. A field device used in automation technology for detecting a process variable of a medium, comprising:
a capacitive sensor assembly, including:
a first housing element and a second housing element; and
a circuit carrier;
wherein the second housing element spatially surrounds the first housing element at least in sections such that a gap is present between an inner wall of the second housing element and an outer wall of the first housing element,
wherein the inner wall of the second housing element and/or the outer wall of the first housing element is electrically conductive,
wherein the circuit carrier has at least one gap section projecting into the gap with a circuit arrangement,
wherein the circuit arrangement has at least one electrically conductive conductor element with an electrically insulating layer covering the conductor element,
wherein the gap section projects into the gap such that a first surface of the gap section faces the outer wall of the first housing element and a second surface of the gap section faces the inner wall of the second housing element,
wherein the second surface of the gap section is opposite the first surface of the gap section,
wherein the gap section that faces an electrically conductive wall viz., the inner wall of the second housing element and/or the outer wall of the first housing element, has the electrically insulating layer such that:
at a first electrode of a capacitor unit is formed by the at least one electrically conductive conductor element of the circuit arrangement of the gap section,
one or more second electrodes of the capacitor unit are formed by the electrically conductive walls facing the gap section, viz., the inner wall of the second housing element and/or the outer wall of the first housing element, and
a dielectric of the capacitor unit is formed by the volume occupied in the gap between the gap section and the electrically conductive wall facing the gap section, viz., the inner wall of the second housing element and/or the outer wall of the first housing element, and by an electrically insulating portion of the gap section.

45. The field device according to claim 44, wherein the capacitor unit serves as a signal generation unit of the field device for generating at least one capacitive measurement signal dependent upon a process variable, and
wherein the field device has a measuring electronics unit connected to the signal generation unit that serves to process and/or forward the capacitive measuring signal generated by the signal generation unit.

46. The field device according to claim 44, further comprising:
a rigid circuit board that is electrically contacted with the connecting element via an electrical feedthrough,
wherein the rigid circuit board is part of the measuring electronics unit.

47. The field device according to claim 44,
wherein the circuit carrier is a semi-flexible circuit board having a rigid section and the rigid section includes the connecting section and/or adjoins the connecting section, and
wherein the rigid section of the semi-flexible circuit board is part of the measuring electronics unit.

48. The field device according to claim 46, further comprising:
a media-contacting section,
wherein the measuring electronics unit is arranged at a distance of at least 50 mm from the media-contacting section.

49. The field device according to claim 48,
wherein the medium is a flowing fluid, and
wherein the sensor assembly serves as a sensor element for capacitively detecting pressure fluctuations of a Kármán vortex street formed in the flowing fluid.
